(19) United States
(12) Patent Application Publication
(10) Pub. No.: US 2020/0082993 A1
(43) Pub. Date: Mar. 12, 2020

(54) STACKED CAPACITOR ASSEMBLY STRUCTURE

(71) Applicant: ANDAQ TECHNOLOGY CO., LTD., Taipei City (TW)

(72) Inventor: CHIA-YU WU, NEW TAIPEI CITY (TW)

(21) Appl. No.: 16/416,676

(22) Filed: May 20, 2019

(30) Foreign Application Priority Data
Sep. 12, 2018 (TW) 107132059

(51) Int. Cl. H01G 9/025; H01G 9/15; H01G 9/04

(52) U.S. Cl. CPC H01G 9/025; H01G 2009/0014; H01G 9/04; H01G 9/15

(57) ABSTRACT

A stacked capacitor assembly structure includes a capacitor unit and an electrode unit. The capacitor unit includes a plurality of stacked capacitors. Each stacked capacitor has a positive portion and a negative portion. The electrode unit includes a first electrode structure and a second electrode structure. The first electrode structure serves as a first outer end electrode to cover the first exposed portion of the capacitor unit and electrically contacts the positive portion of the stacked capacitor, and the second electrode structure serves as a second outer end electrode to cover the second exposed portion of the capacitor unit and electrically contacts the negative portion of the stacked capacitor.

This application claims the benefit of priority to Taiwan Patent Application No. 107132059, filed on Sep. 12, 2018. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a capacitor assembly structure, and more particularly to a stacked capacitor assembly structure.

### BACKGROUND OF THE DISCLOSURE

Capacitors have been widely used in consumer electronics, computer motherboards and their peripherals, power supplies, communication products, and basic automotive components. The main functions of capacitors includes: filtering, bypassing, rectification, coupling, decoupling and phase inversion. Capacitors are one of the indispensable components in electronic products. Capacitors have different types according to different materials and uses, including aluminum electrolytic capacitors, tantalum electrolytic capacitors, laminated ceramic capacitors, and film capacitors. In the related art, the solid electrolytic capacitor has the advantages of small size, large capacitance, superior frequency characteristics, and can decouple the power supply circuit for the central processing unit. In general, a stack of a plurality of capacitor units can be utilized to form a high-capacity solid electrolytic capacitor. The stacked solid-state electrolytic capacitor of the related art includes a plurality of capacitor units and a lead frame, wherein each capacitor unit includes an anode portion and a cathode portion, and an insulating portion that electrically insulates the anode portion from the cathode portion. In particular, the cathode portions of the capacitor unit are stacked on each other, and a plurality of capacitor units are electrically connected to each other by providing a conductor layer between adjacent capacitor units. However, stacked capacitors of the related art still have room for improvement.

### SUMMARY OF THE DISCLOSURE

In response to the above-referenced technical inadequacies, the present disclosure provides a stacked capacitor assembly structure.

In one aspect, the present disclosure provides a technical solution of providing a stacked capacitor assembly structure including: a capacitor unit, a package unit, and an electrode unit. The capacitor unit includes a plurality of stacked capacitors, each of which has a positive portion and a negative portion. The package unit includes an insulation package partially covering the capacitor unit that has a first exposed portion and a second exposed portion exposed from the package unit. The electrode unit includes a first electrode structure and a second electrode structure. The first electrode structure serves as a first outer end electrode to cover the first exposed portion of the capacitor unit and electrically contacts the positive portion of the stacked capacitor, and the second electrode structure serves as a second outer end electrode to cover the second exposed portion of the capacitor unit and electrically contacts the negative portion of the stacked capacitor.

In one aspect, the present disclosure provides another technical solution adopted of providing a stacked capacitor assembly structure including: a capacitor unit, a package unit, and an electrode unit. The capacitor unit includes a plurality of stacked capacitors, each of which has a positive portion and a negative portion. The package unit includes an insulation package partially covering the capacitor unit. The electrode unit includes a first electrode structure and a second electrode structure. The first electrode structure serves as an outer end electrode to cover an exposed portion of the capacitor unit and electrically contact one of the positive portion and the negative portion of the stacked capacitor and the second electrode structure serves as a lead frame electrode pin to support the capacitor unit and electrically contact the other of the positive portion and the negative portion of the stacked capacitor.

In certain embodiments, the present disclosure provides another technical solution of providing a stacked capacitor assembly structure including: a capacitor unit and an electrode unit. The capacitor unit includes a plurality of stacked capacitors, each of which has a positive portion and a negative portion. The electrode unit includes a first electrode structure and a second electrode structure. The first electrode structure serves as an outer end electrode to cover one end of the capacitor unit and electrically contact the middle portion and the negative portion of the stacked capacitor, and the second electrode structure is electrically connected to the other of the positive portion and the negative portion of the stacked capacitor.

Therefore, one of the beneficial effects of the present disclosure is that the stacked capacitor assembly structure provided by the present disclosure can adopt the technical feature of “the first electrode structure serving as an outer end electrode to cover one end of the capacitor unit and electrically contacting one of the positive portion and the negative portion of the stacked capacitor.”, so as to effectively improve the production efficiency of the stacked capacitor assembly structure.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a side schematic view of capacitor assembly structure according to a first embodiment of the present disclosure.

FIG. 2 is a side schematic view of capacitor assembly structure according to a second embodiment of the present disclosure.

FIG. 3 is a side schematic view of capacitor assembly structure according to a third embodiment of the present disclosure.

FIG. 4 is a side schematic view of capacitor assembly structure according to a fourth embodiment of the present disclosure.

FIG. 5 is a side schematic view of capacitor assembly structure according to a fifth embodiment of the present disclosure.

FIG. 6 is a side schematic view of capacitor assembly structure according to a sixth embodiment of the present disclosure.

FIG. 7 is a side schematic view of capacitor assembly structure according to a seventh embodiment of the present disclosure.

FIG. 8 is a side schematic view of capacitor assembly structure according to an eighth embodiment of the present disclosure.

FIG. 9 is a side schematic view of capacitor assembly structure according to a ninth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

Referring to FIG. 1, a first embodiment of the present disclosure provides a stacked capacitor assembly structure Z including a capacitor unit 1, a package unit 2, and an electrode unit 3. For example, the stacked capacitor assembly structure Z may be a stacked capacitor package structure, a stacked capacitor component belonging to a component type, or a stacked solid electrolytic capacitor defined by the type of use.

First, the capacitor unit 1 includes a plurality of stacked capacitors 11, and each of the stacked capacitors 11 has a positive portion P and a negative portion N. Further, a plurality of stacked capacitors 11 are sequentially stacked, and each of the two stacked capacitors 11 can be electrically connected to each other through a conductive adhesive Cc and the plurality of positive electrode portions P of the plurality of stacked capacitors 11 are separated from each other without contact. For example, the stacked capacitor 11 includes a metal foil, an oxide layer, a conductive polymer layer, a carbon paste layer, and a silver paste layer. An oxide layer is formed on the outer surface of the metal foil to completely cover the metal foil. A conductive polymer layer is formed on the oxide layer to coat the oxide layer partially. The carbon paste layer is formed on the conductive polymer layer to coat the conductive polymer layer. A silver paste layer is formed on the carbon paste layer to coat the conductive polymer layer. According to different requirements, the metal foil may be aluminum, copper or any metal material, and the surface of the metal foil has a porous corrosion layer, so that the metal foil may be a corrosion foil with a porous corrosion layer. When the metal foil is oxidized, an oxide layer is formed on the surface of the metal foil, and the metal foil on which the oxide layer is formed may be referred to as a valve metal foil. However, the disclosure is not limited thereto.

Furthermore, the stacked capacitor 11 further includes a surrounding barrier layer formed around an outer surface of the oxide layer. For example, the distance of an outer peripheral surface of the surrounding barrier layer relative to the oxide layer may be greater than, less than, or equal to the distance of an outer peripheral surface of the silver paste layer from the oxide layer. In addition, one end of the conductive polymer layer, one end of the carbon paste layer, and one end of the silver paste layer would contact or separate the surrounding barrier layer so that the length of the conductive polymer layer, the length of the carbon paste layer, and the length of the silver paste layer are limited by the surrounding barrier layer. In addition, depending on different needs, the surrounding barrier layer may be a conductive layer made of any conductive material (such as Al or Cu), or an insulating layer made of any insulating material (such as epoxy or silicon). It should be noted that the stacked capacitor 11 may not use a surrounding barrier layer depending on different needs. However, the disclosure is not limited thereto.

Furthermore, the package unit 2 includes an insulation package 20 partially covering the capacitor unit 1, and the capacitor unit 1 has a first exposed portion 101 and a second exposed portion 102 exposed from the package unit 2. That is, the first exposed portion 101 and the second exposed portion 102 of each of the stacked capacitors 11 are exposed by the insulation package 20 without being covered. For example, the insulation package 20 can be made of any insulating material such as epoxy or silicon. However, the disclosure is not limited thereto.

In addition, the electrode unit 3 includes a first electrode structure 31 and a second electrode structure 32. Furthermore, the first electrode structure 31 can serve as a “first outer end electrode” to cover the first exposed portion 101 of the capacitor unit 1 and electrically contact the positive portion P of the stacked capacitor 11. In addition, the second electrode structure 32 can serve as a “second outer end electrode” to cover the second exposed part 102 of the capacitor unit 1 and electrically contact the negative portion N of the stacked capacitor 11. In other words, the first electrode structure 31 can serve as an outer end electrode to cover one end of the capacitor unit 1 and electrically contact one of the positive portion P and the negative portion N of the stacked capacitor 11, and the second electrode structure 32 can serve as the other outer end electrode to cover the other side end portion of the capacitor unit 1 and electrically contact the other of the positive portion P and the negative portion N of the stacked capacitor 11.

Thereby, the first electrode structure 31 as the first outer end electrode and the second electrode structure 32 as the second outer end electrode can be respectively used to cover the first exposed portion 101 of the stacked capacitor 11 and the second exposed portion 102 of the stacked capacitor 11 (that is, the first electrode structure 31 and the second electrode structure 32 do not need to be inserted into the interior of the insulation package 20 like the electrode pins of the lead frame.), so that the first electrode structure 31 of the electrode unit 3 and the first electrode structure of the second electrode structure 32 can be quickly formed on the opposite side ends of the insulation package 20 without performing any bending step (a step of bending the electrode pins of the lead frame), thereby effectively improving the production efficiency of the stacked capacitor assembly structure Z.

### Second Embodiment

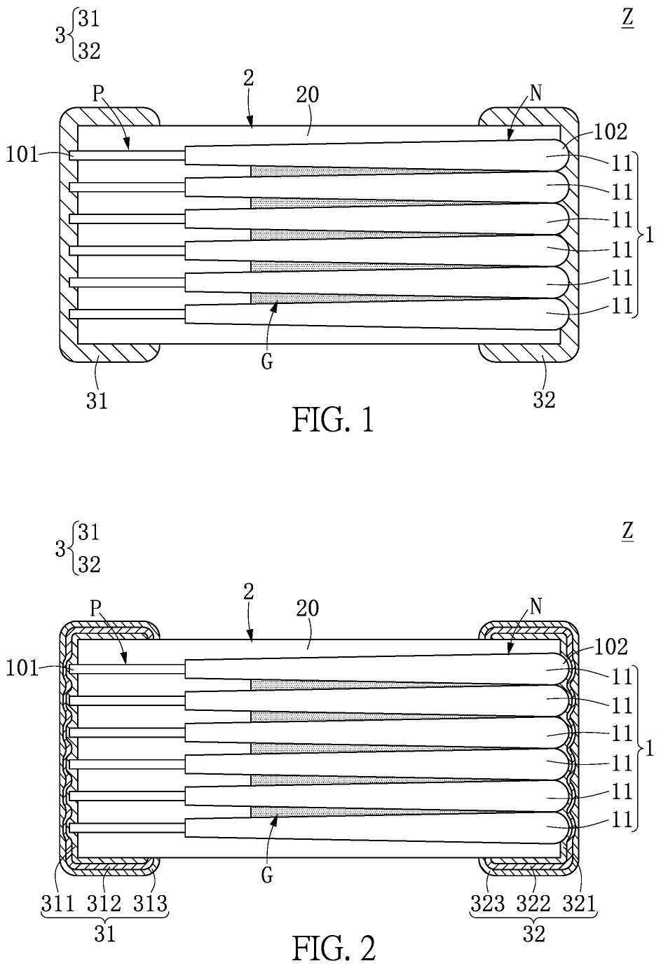

Referring to FIG. 2, a second embodiment of the present disclosure provides a stacked capacitor assembly structure Z including a capacitor unit 1, a package unit 2, and an electrode unit 3, the main difference between the first embodiment and the second embodiment of the present disclosure is that, as can be seen from a comparison between FIG. 2 and FIG. 1, in the second embodiment, the first electrode structure 31 includes a first inner conductive layer 311 covering the first exposed portion 101 and electrically contacting the positive electrode portion P, and a first intermediate conductive layer covering the first inner conductive layer 311. The layer 312 and a first outer conductive layer 313 covering the first intermediate conductive layer 312. In addition, the second electrode structure 32 includes a second inner conductive layer 321 covering the second exposed portion 102 and electrically contacting the negative portion N, a second intermediate conductive layer 322 covering the second inner conductive layer 321, and a second outer conductive layer 323 covering the second intermediate conductive layer 322.

For example, the first inner conductive layer 311 and the second inner conductive layer 321 may both include Ag layers (or other conductive materials similar to Ag) or composite layers including Ag layers and conductive diffusion barrier layers, the first intermediate conductive layer. The layer 312 and the second intermediate conductive layer 322 may both be Ni layers or other conductive materials similar to Ni. The first outer conductive layer 313 and the second outer conductive layer 323 may both be Sn layers or other conductive materials similar to Sn. In addition, the conductive diffusion barrier layer is selected from the group consisting of carbon (C), carbon compounds, carbon nanotubes, graphene, silver (Ag), gold (Au), platinum (Pt), palladium (Pb), titanium (TiNx), titanium carbide (TiC), and other antioxidant materials, however, the disclosure is not limited thereto. Therefore, by adopting the conductive diffusion preventing layer, external moisture does not pass through the electrode unit 3 to enter the capacitor unit 1, thereby improving the airtightness and weather resistance of the stacked capacitor assembly structure Z.

### Third Embodiment

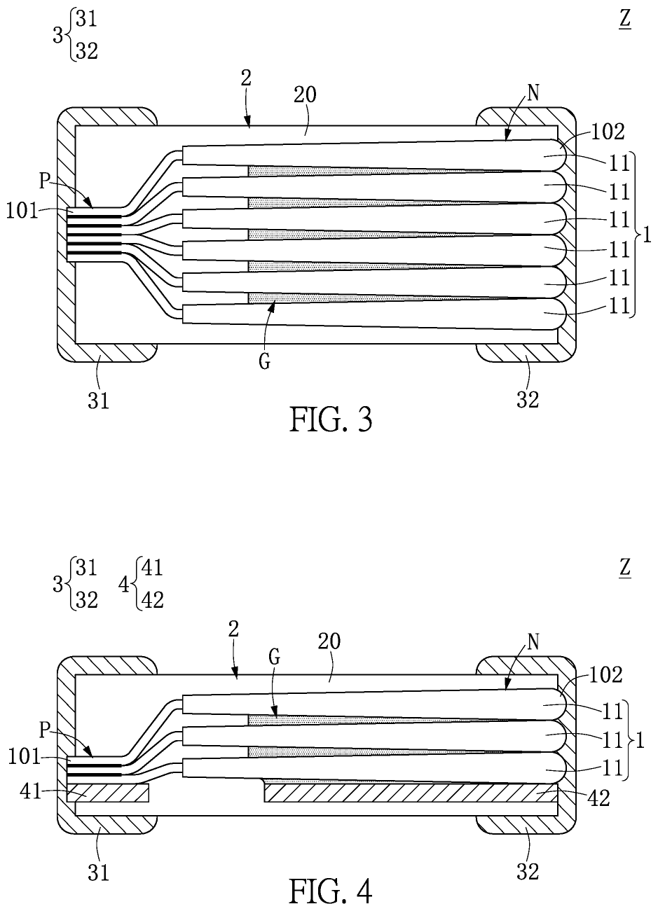

Referring to FIG. 3, a third embodiment of the present disclosure provides a stacked capacitor assembly structure Z including a capacitor unit 1, a package unit 2, and an electrode unit 3, the main difference between the first embodiment and the third embodiment of the present disclosure is that, as can be seen from a comparison between FIG. 3 and FIG. 1 in the third embodiment, the plurality of positive portions P of the plurality of stacked capacitors 11 are sequentially stacked. For example, the plurality of positive portions P may be sequentially stacked by laser welding, impedance welding, or other kinds of welding methods, however, the present disclosure is not limited thereto.

It should be noted that the first electrode structure 31 and the second electrode structure 32 of the electrode unit 3 of the third embodiment can be replaced with the first electrode structure 31 and the second electrode structure 32 of the electrode unit 3 disclosed in the second embodiment.

### Fourth Embodiment

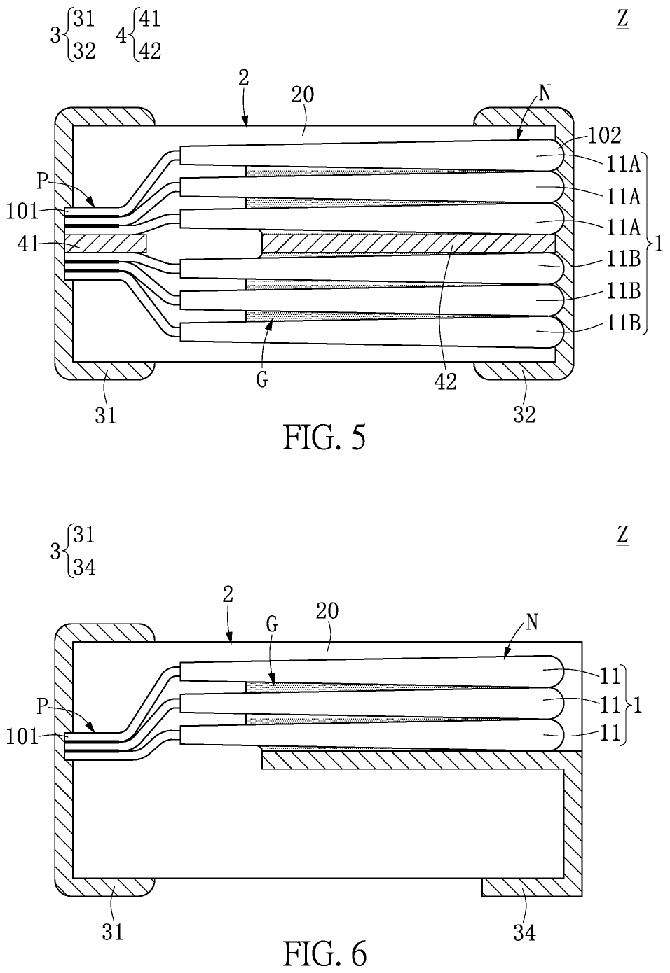

Referring to FIG. 4, a fourth embodiment of the present disclosure provides a stacked capacitor assembly structure Z including a capacitor unit 1, a package unit 2, and an electrode unit 3, the main difference between the first embodiment and the fourth embodiment of the present disclosure is that, as can be seen from a comparison between FIG. 4 and FIG. 1 in the fourth embodiment, The stacked capacitor assembly structure Z of the fourth embodiment further includes a supporting unit 4, and the supporting unit 4 includes a first supporting element 41 and a second supporting element 42. In addition, the plurality of stacked capacitors 11 can be sequentially stacked on the first supporting element 41 and the second supporting element 42, and the positive portion P and the negative portion N of the stacked capacitor 11 can be electrically and respectively connected to the first supporting element 41 and the second supporting element 42. In other words, the plurality of stacked capacitors 11 of the fourth embodiment can be supported in advance by using the first supporting element 41 and the second supporting element 42, which is beneficial to subsequent processing.

It should be noted that the first electrode structure 31 and the second electrode structure 32 of the electrode unit 3 of the fourth embodiment can be replaced with the first electrode structure 31 and the second electrode structure 32 of the electrode unit 3 disclosed in the second embodiment.

### Fifth Embodiment

Referring to FIG. 5, a fifth embodiment of the present disclosure provides a stacked capacitor assembly structure Z including a capacitor unit 1, a package unit 2, and an electrode unit 3, the main difference between the fourth embodiment and the fifth embodiment of the present disclosure is that, as can be seen from the comparison between FIG. 4 and FIG. 5 in the fifth embodiment, a plurality of stacked capacitors can be divided into a plurality of first stacked capacitors 11A and a plurality of second stacked capacitors 11B. Further, the plurality of first stacked capacitors 11A can be sequentially stacked on the top end of a first supporting element 41 and the top end of a second supporting element 42, and the plurality of second stacked capacitors 11B can be sequentially stacked on the bottom end of the first supporting element 41 and a bottom end of the second supporting element 42. In other words, the plurality of first stacked capacitors 11A and the plurality of second stacked capacitors 11B of the fifth embodiment can be supported in advance by using the first supporting element 41 and the second supporting element 42, which is beneficial to subsequent processing. It should be noted that the first electrode structure 31 and the second electrode structure 32 of the electrode unit 3 of the fifth embodiment can be replaced with the first electrode structure 31 and the second electrode structure 32 of the electrode unit 3 disclosed in the second embodiment.

### Sixth Embodiment

Referring to FIG. 6, a sixth embodiment of the present disclosure provides a stacked capacitor assembly structure Z including a capacitor unit 1, a package unit 2, and an electrode unit 3. The capacitor unit 1 includes a plurality of stacked capacitors 11, and each of the stacked capacitors 11 has a positive portion P and a negative portion N. The package unit 2 includes an insulation package 20 partially covering the capacitor unit 1, and the electrode unit 3 includes a first electrode structure 31 and a second electrode structure 34.

The main difference between the fifth embodiment and the sixth embodiment of the present disclosure is that, as can be seen from the comparison between FIG. 1 and FIG. 6 in the fifth embodiment, the first electrode structure 31 can serve as an “outer end electrode” to cover an exposed portion of the capacitor unit 1 (that is, the first exposed portion 101) and electrically contact the positive portion P of the stacked capacitor 11. In addition, the second electrode structure 34 can function as a “lead electrode pin” to support the capacitor unit 1 and electrically contact the negative portion N of the stacked capacitor 11. In other words, the first electrode structure 31 can serve as an outer end electrode to cover one end of the capacitor unit 1 and electrically contact the positive electrode portion P of the stacked capacitor 11, and the second electrode structure 34 is electrically connected to the negative electrode portion N of the stacked capacitor 11. Furthermore, the plurality of positive portions P of the plurality of stacked capacitors 11 is sequentially stacked on the lead frame electrode pins (that is, the second electrode structure 34).

Thereby, the first electrode structure 31 serving as the outer end electrode can be used to cover the first exposed portion 101 of the stacked capacitor 11 (that is, the first electrode structure 31 does not need to be inserted into the interior of the insulation package 20 like the electrode pins of the lead frame), so that the first electrode structure 31 of the electrode unit 3 can be quickly formed on the side end portion of the insulation package 20 without performing any bending step (the steps bending the electrode pins of the lead frame), so as to effectively improve the production efficiency of the stacked capacitor assembly structure Z.

It should be noted that, the first electrode structure 31 of the electrode unit 3 of the sixth embodiment can be replaced with the first electrode structure 31 of the electrode unit 3 disclosed in the second embodiment.

### Seventh Embodiment

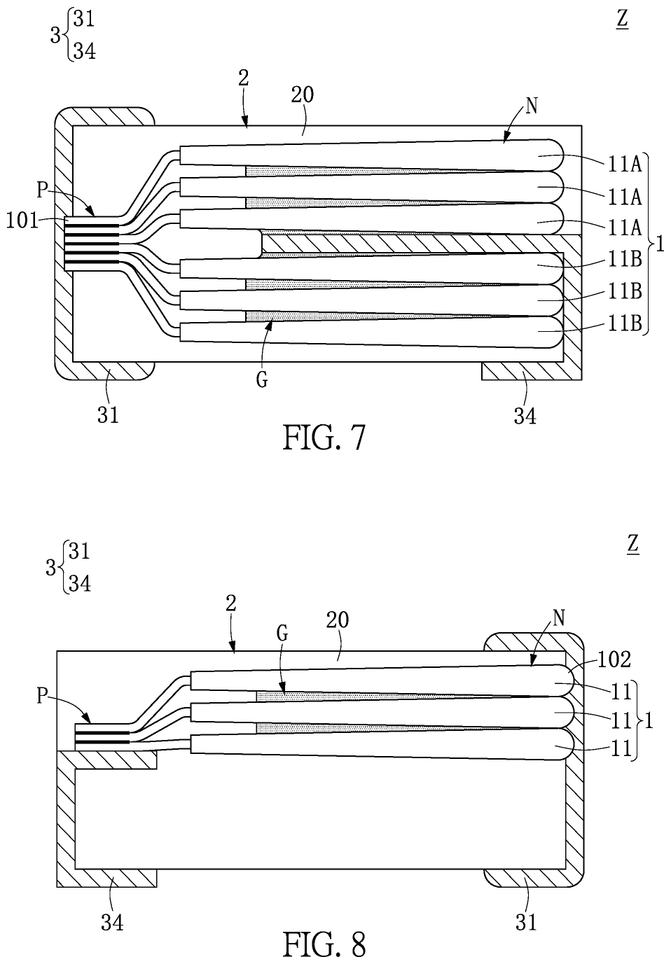

Referring to FIG. 7, a seventh embodiment of the present disclosure provides a stacked capacitor assembly structure Z including a capacitor unit 1, a package unit 2, and an electrode unit 3, the main difference between the sixth embodiment and the seventh embodiment of the present disclosure is that, as can be seen from the comparison between FIG. 6 and FIG. 7 in the seventh embodiment, the plurality of stacked type capacitors can be divided into a plurality of first stacked type capacitors 11A and a plurality of second stacked type capacitors 11B. In addition, a plurality of positive electrode portions P of the plurality of first stacked capacitors 11A are sequentially stacked on the top end of the lead frame electrode pins (that is, on the top end of the buried portion of the second electrode structure 34), and the plurality of positive electrode portions P of the two stacked capacitors 11B are sequentially stacked on the bottom end of the lead frame electrode pins (that is, on the bottom end of the buried portion of the second electrode structure 34).

It should be noted that, the first electrode structure 31 of the electrode unit 3 of the seventh embodiment can be replaced with the first electrode structure 31 of the electrode unit 3 disclosed in the second embodiment.

### Eighth Embodiment

Referring to FIG. 8, an eighth embodiment of the present disclosure provides a stacked capacitor assembly structure Z including a capacitor unit 1, a package unit 2, and an electrode unit 3, the main difference between the sixth embodiment and the eighth embodiment of the present disclosure is that, as can be seen from the comparison between FIG. 6 and FIG. 8 in the eighth embodiment, the first electrode structure 31 can serve as an “outer end electrode” to cover an exposed portion of the capacitor unit 1 (that is, the second exposed portion 102) and electrically contact the negative portion N of the stacked capacitor 11. In addition, the second electrode structure 34 can function as a “lead frame electrode pin” to support the capacitor unit 1 and electrically contact the positive electrode portion P of the stacked capacitor 11. In other words, the first electrode structure 31 can serve as an outer end electrode to cover one end of the capacitor unit 1 and electrically contact the negative portion N of the stacked capacitor 11, and the second electrode structure 34 is electrically connected to the positive portion P of the stacked capacitor 11.

Thereby, the first electrode structure 31 serving as the outer end electrode can be used to cover the second exposed portion 102 of the stacked capacitor 11 (that is, the first electrode structure 31 does not need to be inserted into the interior of the insulation package 20 like the electrode pins of the lead frame), so that the first electrode structure 31 of the electrode unit 3 can be quickly formed on the side end portion of the insulation package 20 without performing any bending step (the steps bending the electrode pins of the lead frame), so as to effectively improve the production efficiency of the stacked capacitor assembly structure Z.

It should be noted that, the first electrode structure 31 of the electrode unit 3 of the eighth embodiment can be replaced with the first electrode structure 31 of the electrode unit 3 disclosed in the second embodiment.

### Ninth Embodiment

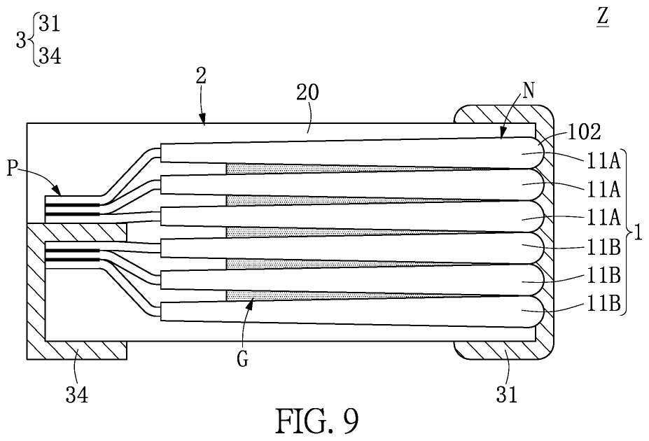

Referring to FIG. 9, a ninth embodiment of the present disclosure provides a stacked capacitor assembly structure Z including a capacitor unit 1, a package unit 2, and an electrode unit 3, the main difference between the eighth embodiment and the ninth embodiment of the present disclosure is that, as can be seen from the comparison between FIG. 8 and FIG. 9 in the ninth embodiment the plurality of stacked capacitors can be divided into a plurality of first stacked capacitors 11A and a plurality of second stacked capacitors 11B. In addition, a plurality of positive portions P of the plurality of first stacked capacitors 11A are sequentially stacked on the top end of the lead frame electrode pins (that is, on the top end of the buried portion of the second electrode structure 34), and a plurality of the plurality of positive portions P of the two stacked capacitors 11B are sequentially stacked on the bottom end of the lead frame electrode pins (that is, on the bottom end of the buried portion of the second electrode structure 34).

It should be noted that, the first electrode structure 31 of the electrode unit 3 of the ninth embodiment can be replaced with the first electrode structure 31 of the electrode unit 3 disclosed in the second embodiment.

In conclusion, one of the beneficial effects of the present disclosure is that the stacked capacitor assembly structure Z provided by the present disclosure can effectively increase the production efficiency of the stacked capacitor component structure Z by the technical feature of “the first electrode structure 31 serves as an outer end electrode to cover one end of the capacitor unit 1 and electrically contacts one of the positive portion P and the negative portion N of the stacked capacitor 11”.

Thereby, the first electrode structure 31 as the outer end electrode can be used to cover the first exposed portion 101 or the second exposed portion 102 of the stacked capacitor 11 (that is, the first electrode structure 31 does not need to be inserted into the interior of the insulation package 20 like the electrode pins of the lead frame), so as to effectively improve the production efficiency of the stacked capacitor assembly structure Z.

It should be noted that the insulation package 20 shown in FIG. 1 to FIG. 9 is only one example of the present disclosure. In other feasible embodiments, the present disclosure can omit the use of the insulation package 20 and directly use the capacitor unit 1 and the electrode unit 3.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A stacked capacitor assembly structure comprising:
a capacitor unit including a plurality of stacked capacitors, each of the stacked capacitors having a positive portion and a negative portion;
a package unit including an insulation package partially covering the capacitor unit, the capacitor unit having a first exposed portion and a second exposed portion exposed from the package unit; and
an electrode unit including a first electrode structure and a second electrode structure;
wherein the first electrode structure serves as a first outer end electrode to cover the first exposed portion of the capacitor unit and to electrically contact the positive portion of the stacked capacitor;
wherein the second electrode structure serves as a second outer end electrode to cover the second exposed portion of the capacitor unit and to electrically contact the negative portion of the stacked capacitor.

2. The stacked capacitor assembly structure according to claim 1, wherein a plurality of the stacked capacitors are sequentially stacked, and each of the two stacked capacitors is electrically connected to each other by a conductive adhesive, and a plurality of positive electrode portions of the plurality of stacked capacitors are sequentially stacked or separated from each other.

3. The stacked capacitor assembly structure according to claim 1, further comprising, a supporting unit including a first supporting element and a second supporting element, the plurality of stacked capacitors being sequentially stacked on the first supporting element and the second supporting element, and the positive electrode portion and the negative electrode portion of the stacked capacitor being electrically connected to the first supporting element and the second supporting element.

4. The stacked capacitor assembly structure according to claim 1, further comprising, a supporting unit including a first supporting element and a second supporting element, the positive portion and the negative portion of the stacked capacitor being electrically and respectively connected to the first supporting element and the second supporting element, wherein the plurality of stacked capacitors are divided into a plurality of first stacked capacitors and a plurality of second stacked capacitors, a plurality of the first stacked capacitors are sequentially stacked on a top end of the first supporting element and a top end of the second supporting element, and a plurality of the second stacked capacitors are sequentially stacked on a bottom end of the first supporting element and a bottom end of the second supporting element.

5. The stacked capacitor assembly structure according to claim 1, wherein the first electrode structure includes a first inner conductive layer covering the first exposed portion and electrically contacting the positive portion, a first intermediate conductive layer covering the first inner conductive layer, and a first outer conductive layer covering the first intermediate conductive layer, and the second electrode structure includes a second inner conductive layer covering the second exposed portion and electrically contacting the negative portion, a second intermediate conductive layer covering the second inner conductive layer, and a second outer conductive layer covering the second intermediate conductive layer; wherein the first inner conductive layer and the second inner conductive layer respectively include an Ag layer or a composite layer including an Ag layer and a conductive diffusion barrier layer, and the first intermediate conductive layer and the second intermediate conductive layer are both Ni layers, while the first outer conductive layer and the second outer conductive layer are both Sn layers, and the conductive diffusion barrier layer is selected from the group consisting of carbon, carbon compounds, carbon nanotubes, graphene, silver, gold, platinum, palladium, titanium nitride, and titanium carbide.

6. A stacked capacitor assembly structure comprising:
a capacitor unit including a plurality of stacked capacitors, each of the stacked capacitors has a positive portion and a negative portion;
a package unit including an insulation package partially covering the capacitor unit; and
an electrode unit including a first electrode structure and a second electrode structure;
wherein the first electrode structure serves as an outer end electrode to cover an exposed portion of the capacitor unit and to electrically contact one of the positive portion and the negative portion of the stacked capacitor;
wherein the second electrode structure serves as a lead frame electrode pin to support the capacitor unit and electrically contact the other one of the positive electrode portion and the negative electrode portion of the stacked capacitor.

7. The stacked capacitor assembly structure according to claim 6, wherein the plurality of the stacked capacitors are sequentially stacked, and a plurality of positive portions of the plurality of stacked capacitors are sequentially stacked on the lead frame electrode pins; wherein the first electrode structure includes a first inner conductive layer covering the first exposed portion and electrically contacting the positive portion, a first intermediate conductive layer covering the first inner conductive layer, and a first outer conductive layer covering the first intermediate conductive layer; the first inner conductive layer includes an Ag layer or a composite layer including an Ag layer and a conductive diffusion barrier layer, the first intermediate conductive layer is a Ni layer, the first outer conductive layer is a Sn layer, and the conductive diffusion barrier layer is selected from the group consisting of carbon, carbon compounds, carbon nanotubes, graphene, silver, gold, platinum, palladium, titanium nitride, and titanium carbide.

8. The stacked capacitor assembly structure according to claim 6, wherein the plurality of stacked capacitors are divided into a plurality of first stacked capacitors and a plurality of second stacked capacitors, and the plurality of positive portions of the plurality of first stacked capacitors are sequentially stacked on the lead frame electrode pins; the plurality of positive portions of the plurality of second stacked capacitors are sequentially stacked on a bottom end of the lead frame electrode pins; wherein the first electrode structure includes a first inner conductive layer covering the first exposed portion and electrically contacting the positive portion, a first intermediate conductive layer covering the first inner conductive layer, and a first outer conductive layer covering the first intermediate conductive layer, the first inner conductive layer includes an Ag layer or a composite layer including an Ag layer and a conductive diffusion barrier layer, the first intermediate conductive layer is a Ni layer, the first outer conductive layer is a Sn layer, and the conductive diffusion barrier layer is selected from the group consisting of carbon, carbon compounds, carbon nanotubes, graphene, silver, gold, platinum, palladium, titanium nitride, and titanium carbide.

9. A stacked capacitor assembly structure comprising:
a capacitor unit including a plurality of stacked capacitors, each of the stacked capacitors has a positive portion and a negative portion; and
an electrode unit including a first electrode structure and a second electrode structure;
wherein the first electrode structure serves as an outer end electrode so as to cover one end of the capacitor unit and to electrically contact one of the positive portion and the negative portion of the stacked capacitor;
wherein the second electrode structure is electrically connected to the other of the positive electrode portion and the negative electrode portion of the stacked capacitor.

10. The stacked capacitor assembly structure according to claim 9, further comprising: a supporting unit including a first supporting element and a second supporting element, and the plurality of stacked capacitors are sequentially stacked on the first supporting element and the second supporting element, the positive portion and the negative portion of the stacked capacitor being respectively and electrically connected to the first supporting element and the second supporting element; wherein the first electrode structure includes a first inner conductive layer covering the first exposed portion and electrically contacting the positive electrode portion, a first intermediate conductive layer covering the first inner conductive layer, and a first outer conductive layer covering the first intermediate conductive layer, and the second electrode structure includes a second inner conductive layer covering the second exposed portion and electrically contacting the negative electrode portion, and a second intermediate conductive layer covering the second inner conductive layer and a second outer conductive layer covering the second intermediate conductive layer.
